(19) United States
(12) Patent Application Publication
(10) Pub. No.: US 2010/0266112 A1
(43) Pub. Date: Oct. 21, 2010

(54) METHOD AND DEVICE RELATING TO CONFERENCING

(75) Inventors: David Per BURSTROM, Lund (SE); Andreas BEXELL, Tokyo (JP)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/425,231

(22) Filed: Apr. 16, 2009

(51) Int. Cl. H04M 3/42

(52) U.S. Cl. 379/202.01

(57) ABSTRACT

A system in which a processor processes received signals corresponding to a voice of a particular participant in a multi-party conference; extracts characteristic parameters for the voice of each particular participant; compares results of the characteristic parameters of each particular participant and determines a degree of similarity in the characteristic parameter; and generates a virtual position for each participant voice, using spatial positioning, where a position of voices having similar characteristics are spaced apart from each other in a virtual space.

### TECHNICAL FIELD

The present invention generally relates to an arrangement and a method in a multi-party conferencing system.

### BACKGROUND OF THE INVENTION

A person, using their two ears, is able to generally audibly preserve the direction and distance of a source of sound. Two cues are primarily used in the human auditory system to achieve this perception. These cues are generally referred to as the inter-aural time difference (ITD) and the inter-aural level difference (ILD), which result from the distance between the location two ears and the shadowing caused by the head. In addition to the ITD and ILD cues, a head-related transfer function (HRTF) is used to localize the sound-source in three-dimensional (3D) space. The HRTF is the frequency response from a sound-source to each ear, which can be affected by diffractions and reflections of the sound waves as they propagate in space and pass around the human's torso, shoulders, head, and pinna. Therefore, the HRTF for a sound-source generally differs from person to person.

In an environment where a number of persons are talking at the same time, the human auditory system generally exploits information in the ITD cue, ILD cue, and HRTF, and the ability to selectively focus one's listening attention on the voice of a particular one of the communicators. In addition, the human auditory system generally rejects sounds that are uncorrelated at the two ears, thus allowing the listener to focus on a particular communicator and disregard sounds due to venue reverberation.

The ability to discern or separate apparent sound sources in 3D space is known as sound “spatialization.” The human auditory system has sound spatialization ability which generally allow persons to separate various simultaneously occurring sounds into different auditory objects and selectively focus on (i.e., primarily listen to) one particular sound.

For modern distance conferencing, one key component is a 3D audio spatial separation. This is used to distribute voice conference participants at different virtual positions around the listener. The spatial positioning helps the user distinguish different voices from one another, even when the voices are unrecognizable by the listener.

A wide range of techniques for placing users in the virtual space can be perceived, with the one most readily apparent being a random positioning. Random positioning, however, carries the risk that two similar sounding voices will be placed proximate each other; in which case, benefits of spatial separation will be diminished.

Aspects of spatial audio separation are well known. For example U.S. Pat. No. 7,505,601 relates to adding spatial audio capability by producing a digitally filtered copy of each input signal to represent a contra-lateral-ear signal with each desired speaker location and treating each of a listener's ears as separate end users.

### SUMMARY

This summary is provided to introduce one or more selection of concepts, in a simplified form, that are further described hereafter in the detailed description. This summary is not intended to identify key features or essential features of the claimed subject matter, nor is it intended to be used as an aid in determining the scope of the claimed subject matter.

Embodiments of the invention may be achieved in providing a conferencing system by spatial positioning of conference participants (conferees) in a manner that allows voices, having similar audible qualities to each other, to be positioned in such a way that a user (listener) can readily distinguish different ones of the participants.

In this regard, arrangements in a multi-party conferencing system are provided. A particular arrangement may include a processing unit, in which the arrangement is configured to process at least each received signal corresponding to a voice of a participant, in a multi-party conferencing, and extract at least one characteristic parameter for the voice of each participant; compare results of the at least one characteristic parameters of at least each participant to find a similarity in the at least one characteristic parameter; and generate a virtual position for each participant voice through spatial positioning, in which a position of voices having similar characteristics may be arranged distanced from each other in a virtual space. In the arrangement, the spatializing may be one or more of a virtual sound-source positioning (VSP) method and a sound-field capture (SFC) method. The arrangement may further include a memory unit for storing sound characteristics and relating them to a particular participant profile.

Embodiments of the invention may relate to a computer configured for for handling a multi-party conferencing. The computer may include a unit for receiving signals corresponding to a voice of a participant of the conferencing; a unit configured to analyze the signal; a unit configured to extract at least one characteristic parameter for the voice; a unit configured to compare the at least one characteristic parameter of at least each participant to find a similarity in the at least one characteristic parameter; and a unit configured to generate a virtual position for each participant voice through spatial positioning, in which a position of voices having similar characteristics may be arranged distanced from each other in a virtual space. The computer may further include a communication interface to a communication network.

Embodiments of the invention may relate to a communication device capable of handling a multi-party conferencing. The communication device may include a communication portion; a sound input unit; a sound output unit; a unit configured to analyze a signal received from the communication network; the signal corresponding to voice of a party is the multi-party conferencing; a unit configured to extract at least one characteristic parameter for the voice; a unit configured to compare the at least one characteristic parameter of at least each participant to find a similarity in the at least one characteristic parameter; and a unit configured to generate a virtual position for each participant voice through spatial positioning, in which a position of voices having similar characteristics may be arranged distanced from each other in a virtual space and out put through the sound output unit.

The invention may relate to a method in a multi-party conferencing system, in which the method may include analyzing signal relating to one or more participant voices; processing at least each received signal and extracting at least one characteristic parameter for voice of each participant based on the signal; comparing result of the characteristic parameters to find similarity in the characteristic parameters; and generating a virtual position for each participant voice through spatial positioning, in which position of voices having similar characteristics may be arranged distanced from each other in a virtual space.

### BRIEF DESCRIPTION OF THE DRAWINGS

The present invention will hereinafter be further explained by means of non-limiting examples with reference to the appended figures, in which:

FIG. 1 shows a schematic communication system according to an embodiment of the present invention;

FIG. 2 is block diagram of participant positioning in a system according to FIG. 1;

FIG. 3 shows a schematic computer unit according to an embodiment of the present invention;

FIG. 4 is a flow diagram according to an embodiment of the invention; and

FIG. 5 is schematic communication device according to an embodiment of the present invention.

### DETAILED DESCRIPTION

According to one aspect of the invention, the voice characteristics of the participants of a voice conference system may be used to intelligently position similar ones of the voices far from each other, when applying spatial positioning techniques.

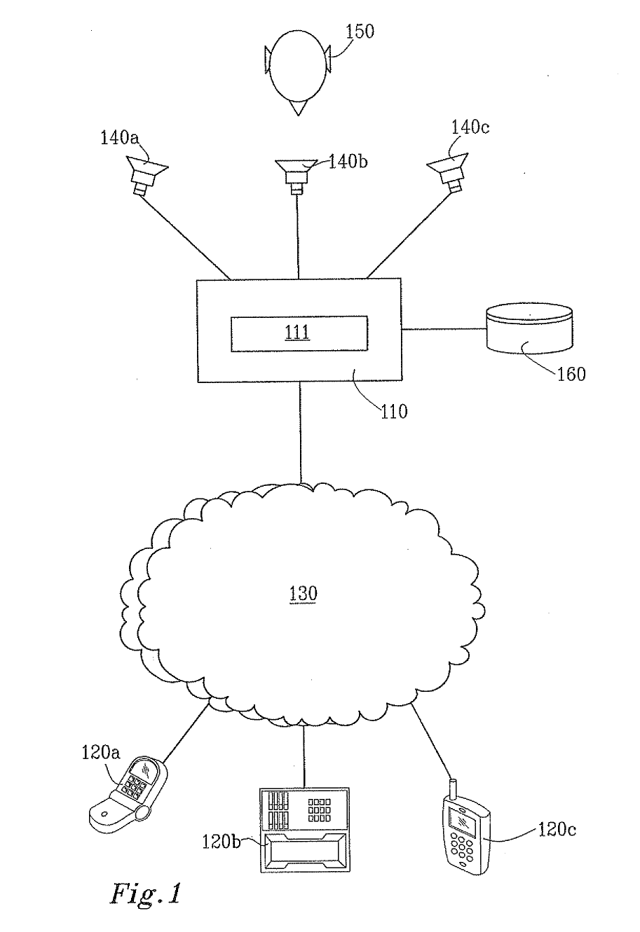

FIG. 1 illustrates a conferencing system 100 according to one embodiment of the invention. Conferencing system 100 may include a computing unit or conference server 110 that may receive incoming calls from a number of user communications devices 120a-120c through one or more types of communication networks 130, such as public land mobile networks, public switched land networks, etc. Computer unit 110 may communicate via one or more speakers 140a-140c to produce spatial positioning of the audio information. Speakers 140a-140c may include a headphone(s).

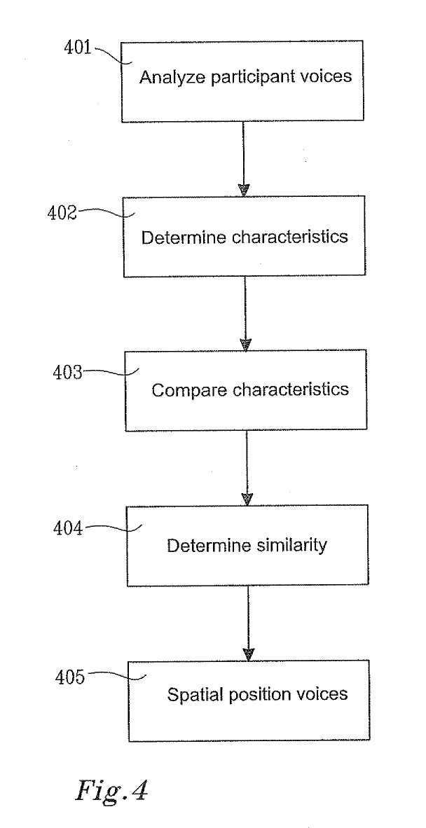

With reference to FIGS. 1 and 4, according to one aspect of the invention, when a user of one of communication devices 120a-120c connects to conference server 110, the received voice of the participant is analyzed 401 (FIG. 4) by an analyzing portion 111 of conference server 110, which may include a server component or a processing unit of the server. The voice may be analyzed and one or more parameters characterizing each voice may be extracted 402 (FIG. 4). The particular information that may be extracted is beyond the scope of the instant application, and the details of need not be specifically addressed herein. The extracted data may be retained and stored with information for recognition of the particular participant corresponding to a particular participant profile for future use. A storing unit 160 may be used for this purpose. The voice characteristics, as defined herein, may include one or more of vocal range (registers), resonance, pitch, amplitude, etc., and/or any other discernible/perceivable audible quality.

As mentioned above, voice/speech recognition systems are well known for skilled persons. For example, some speech recognition systems make use of a Hidden Markov Model (HMM). A Hidden Markov Model outputs, for example, a sequence of n-dimensional real-valued vectors of coefficients (referred to as “cepstral” coefficients), which can be obtained by performing a Fourier transform of a predetermined window of speech, de-correlating the spectrum, and taking the first (most significant) coefficients. The Hidden Markov Model may have, in each state, a statistical distribution of diagonal covariance Gaussians which will give a likelihood for each observed vector. Each word, or each phoneme, will have a different output distribution; a hidden Markov model for a sequence of words or phonemes is made by concatenating the individual trained Hidden Markov Models for the separate words and phonemes. Decoding can make use of, for example, the Viterbi algorithm to find the most likely path.

One embodiment of the present invention may include an encoder to provide, for example, the coefficients, or even the output distribution as the pre-processed voice recognition data. It is noted, however, that other speech models may be used and thus the encoder may function to extract/acquire other speech features, patterns, etc., qualitative and/or quantitative.

When a participant joins a multi-party conference session, the associated voice characteristics may be compared with the other participants' voice characteristics 403 (FIG. 4), and if one or more of the participants are determined to have similar voice patterns 404 (FIG. 4), for example, have similar sounding voices, may be positioned at a selected particular configuration, e.g., as far apart as possible (405). This aids participants to build a distinct and accurate mental image of where participants are physically positioned at the conference.

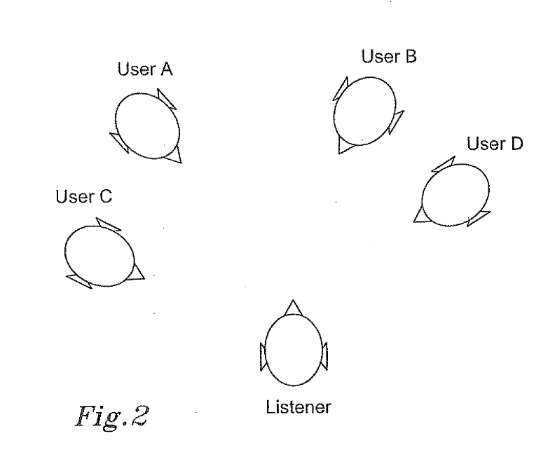

FIG. 2 shows an example of an embodiment of the invention illustrating a “Listener” and a number of “Participants A, B, C, and D.” At the time of joining the conference session, system 110 may determine, for example, that Participant D has a voice pattern sufficiently similar (e.g., meeting and/or exceeding a particular degree of similarity, i.e., a threshold level) to Participant A. In which case, system 100 may be configured to then place participant D to the far right, relative to Listener, to facilitate separation of the voices for enhancing Listener's perceived distinguishability during the conference session.

Degrees of audio similarity may be qualified and/or quantified using a select number of particular audio characteristics. Where it is determined that a particular characteristic can not be detected and/or measured with an acceptable amount of precision, that particular audio characteristic may be excluded from the determination of the degree of audio similarity. In one embodiment, the virtual distancing between each analyzed pair of conferees may be optimized using an algorithm based on the determined degrees of audio similarity between each of the analyzed audio pairs. The distance designated for each conferee pair may be directly proportional to the determined degree of similarity between the voices of each conferee pair. Degrees of determined similarity may be compared to a particular threshold value, and when the threshold value is not met, locating of conferees in the virtual conference may exclude re-positioning of conferees for which the threshold value is not met. Degree of similarity may be quantized, for example, using one, two, three, four, five, and/or any other combination of numbers of select measured voice characteristics. The characteristics may be selected, for example, by a user of the system, from among a set of optional characteristics. In one embodiment, the user may elect to have one or more selected characteristics particularly excluded from the calculation of the degree of similarity, where the vocal parameters not so designated, may be automatically used in the determination of similarity. Select ones of the audio parameters may be weighted in the calculation of similarity. Particular weights may be designated, for example, by a user of the system. In cases where the degree of determined similarity is substantially identical (e.g., identical twin conferees), the system may generate a request for the conferees and/or a conference host, to specifically identify the particular conferees, such that the substantially identical voices can thereafter be distinguished as belonging to two different individuals and not treated as one person.

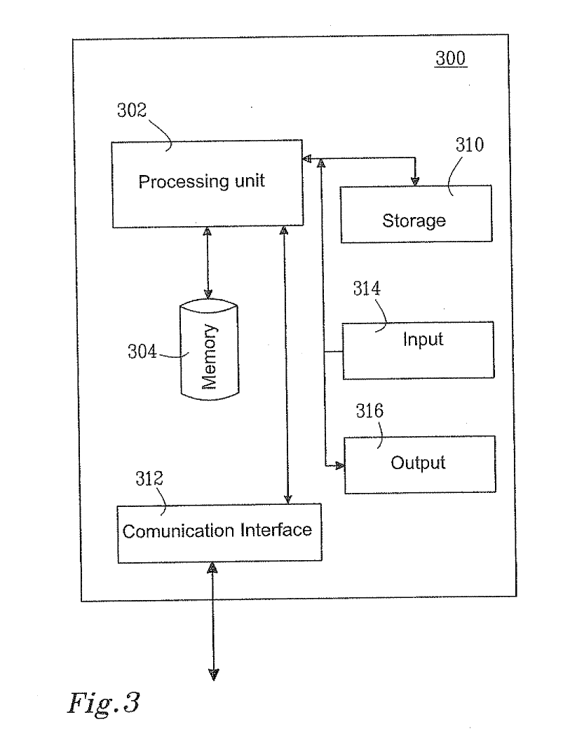

FIG. 3 illustrates a diagram of an exemplary embodiment of a suitable computing system (conferencing server) environment according to the present technique. The environment illustrated in FIG. 3 is only one example of a suitable computing system environment and is not intended to suggest any limitation as to the scope of use or functionality of the present technique. Neither should the computing system environment be interpreted as having any dependency or requirement relating to any one or combination of components exemplified in FIG. 3.

As illustrated in FIG. 3, an exemplary system, for implementing an embodiment of the present technique, may include one or more computing devices, such as computing device 300. In its simplest configuration, computing device 300 may include one or more components, such as at least one processing unit 302 and a memory 304.

Depending on the specific configuration and type of computing device 300, memory 304 may be volatile (such as RAM), non-volatile (such as ROM and flash memory, among others), and/or some combination of the two, or other suitable memory storage device(s).

As exemplified in FIG. 3, computing device 300 may have/perform/be configured with additional features and functionality. By way of example, computing device 300 may include additional (data) storage 310 such as removable storage and/or non-removable storage. This additional storage may include, but is not limited to, magnetic disks, optical disks, and/or tape. Computer storage media may include volatile and non-volatile media, as well as removable and non-removable media implemented in any method or technology. The computer storage media may provide for storage of various information required to operate computing device 300, such as one or more sets of computer-readable instructions associated with an operating system, application programs, and other program modules, and data structures, and the like. Memory 304 and storage 310 are each examples of computer storage media. Computer storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage, and/or other magnetic storage devices, or any other medium which can be used to store the desired information and which can be accessed by computing device 300. Any such computer storage media can be part of (e.g., integral with) and/or separate to, yet selectively accessible to, computing device 300.

As exemplified in FIG. 3, computing device 300 may include a communications interface(s) 312 that may allow computing device 300 to operate in a networked environment and communicate with a remote computing device(s), such as remote computing device(s). Remote computing device can be a PC, a server, a router, a peer device, and/or other common network node, and may include many or all of the elements described herein relative to computing device 300. Communication between one or more computing devices may take place over a network, which provides a logical connection(s) between the computing devices. The logical connection(s) can include one or more different types of networks including, but not limited to, a local area network(s) and wide area network(s).

Such networking environments are commonplace in conventional offices, enterprise-wide computer networks, intranets and the Internet. It will be appreciated that the communications connection(s) and related network (s) described herein are exemplary and other means of establishing communication between the computing devices can be used.

As exemplified in FIG. 3, communications connection and related network(s) are an example of communication media. Communication media typically embodies computer-readable instructions, data structures, program modules, and/or other data in a modulated data signal, and/or any other tangible transport mechanism and may include any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, radio-frequency (RF), infrared and other wireless media. The term “computer readable media,” as used herein, may include storage media and/or communication media.

As exemplified in FIG. 3, computing device 300 may include an input device(s) 314 and an output device(s) 316. Input device 314 may include a keyboard, mouse, pen, touch input device, audio input devices, and cameras, and/or other input mechanisms and/or combinations thereof. A user may enter commands and various types of information into computing device 300 using one or more of input device(s) 314. Exemplary audio input devices (not illustrated) include, but are not limited to, a single microphone, a plurality of microphones in an array, a single audio/video (A/V) camera, and a plurality of cameras in an array. These audio input devices may be used to capture and/or transmit a user's, and/or co-situated group of users', voice(s) and/or other audio information. Exemplary output devices 316 may include, but are not limited to, a display device(s), a printer, and/or audio output devices, among other devices that render information to a user. Exemplary audio output devices (not illustrated) include, but are not limited to, a single audio speaker, a set of audio speakers, and/or headphone sets and/or other listening devices.

These audio output devices may be used to audibly render/present audio information to a user and/or co-situated group of users. With the exception of microphones, loudspeakers, and headphones which are discussed in more detail hereafter, the rest of these input and output devices are not discussed in further detail herein.

One or more present techniques may be described in the general context of computer-executable instructions, such as program modules, which may be executed by one or more processing components associated with computing device 300. Generally, program modules may include routines, programs, objects, components, and/or data structures, among other things, that may perform particular tasks and/or implement particular abstract data types. One or more of the present techniques may be practiced in a distributed computing environment where tasks are performed by one or more remote computing devices that may be linked via a communications network. In a distributed computing environment, for example, program modules may be located in both local and remote computer storage media including, but not limited to, memory 304 and storage device 310.

One or more of the present techniques generally spatializes the audio in an audio conference amongst a number of parties situated remotely from one another. This is in contrast to conventional audio conferencing systems which generally provide for an audio conference that is monaural in nature, due to the fact that they generally support only one audio stream (herein also referred to as an audio channel) from an end-to-end system perspective (i.e., between the parties). One or more of the present techniques generally may involve one or more different methods for spatializing the audio in an audio conference, a virtual sound-source positioning (VSP) method, and/or a sound-field capture (SFC) method. Both of these methods are not detailed herein.

One or more of the present techniques generally results in each participant being more completely immersed in the audio conference and each conferee experiencing the collaboration that transpires as if all the conferees were situated together in the same venue.

The processing unit may receive audio signals belonging to different ones of the participants, e.g., through communication network and/or input portions; and analyze one or more selected ones of the voice characteristics. The processing unit may, upon recognition of a voice, through analyses, fetch necessary information from an associated storage unit.

When the voices are characterized, one or more spatialization methods, as mentioned earlier, may be selectively used to place/position (e.g., “audibly rearrange”) different participants, relative to one another, in the virtual room. The processing unit may compare select ones of a set of distinct characteristics, and voices having the most characteristics determined to be similar may be dynamically placed (e.g., “audibly relocated”) with a greater degree of separation with respect to each other, e.g., as far apart as possible.

The terms, distance and far, as used in herein, may relate to a virtual room or audio space, generated using sound reproducing means, such as speakers or headphones. The term, participant, as used herein, may relate to a user of the system of the invention and may be one of a listener and/or an orator.

It should be noted that the voice of one person may be influenced by, for example, communication device/network quality, and although if a profile is stored it may be analyzed each time a particular conference session may be established.

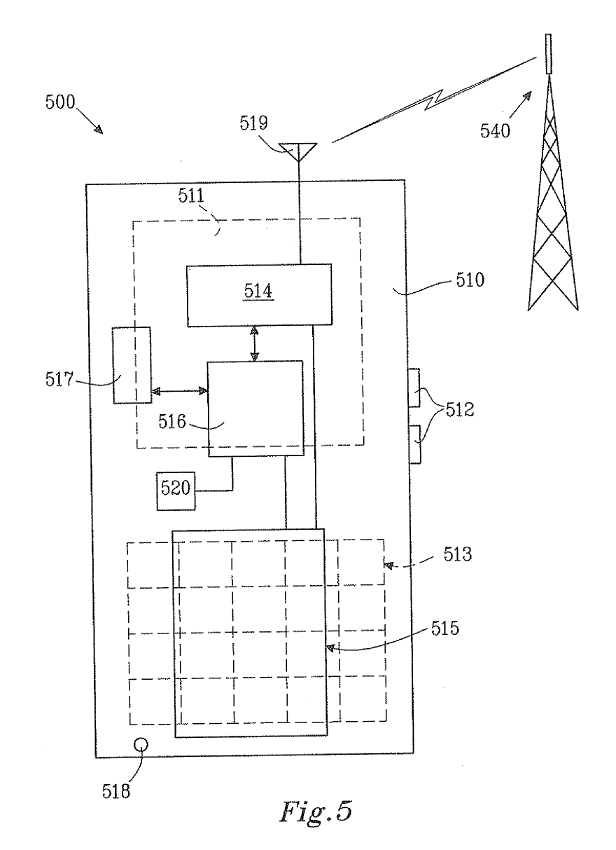

The invention may also be used in a communication device as illustrated in one exemplary embodiment in FIG. 5.

As shown in FIG. 5, an exemplary device 500 may include a housing 510, a display 511, control buttons 512, a keypad 513, a communication portion 514, a power source 515, a microprocessor 516 (or data processing unit), a memory unit 517, a microphone 518, and/or a speaker 520. Housing 510 may protect one or more components of device 500 from outside elements. Display 511 may provide visual and/or graphic information to the user. For example, display 511 may provide information regarding incoming and/or outgoing calls, media, games, phone books, the current time, a web browser, software applications, etc. Control buttons 512 may permit a user of exemplary device 500 to interact with device 500 to cause one or more components of device 500 to perform one or more operations. Keypad 513 may include, for example, a telephone keypad similar to various standard keypad/keyboard configurations. Microphone 518 may used to receive ambient and/or directed sound, such as the voice of a user of device 500.

Communication portion 514 may include parts (not shown) such as a receiver, a transmitter, (or a transceiver), an antenna 519 etc., for establishing and performing communication via one or more communication networks 540.

The microphone and the speaker can be substituted with a headset comprising microphone and earphones, and/or any other suitable arrangement, e.g., Bluetooth® device, etc.

Thus, when communication device 500 is used as a receiver in a conferencing application, the associated processing unit may configured to execute particular ones the instructions serially and/or in parallel, which may generate a perceptible spatial positioning of the participants voices as described above.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

A “device,” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

The above mentioned and described embodiments are only given as examples and should not be limiting to the present invention. Other solutions, uses, objectives, and functions within the scope of the invention as claimed in the below described patent claims should be apparent for the person skilled in the art.

What is claimed is:

1. An arrangement in a multi-party conferencing system, the arrangement comprising:
a processing unit to:
process at least each received signal corresponding to a voice of a particular participant in a multi-party conference;
extract at least one characteristic parameter for the voice of each particular participant;
compare results of the at least one characteristic parameters of at least each particular participant to determine a degree of similarity in the at least one characteristic parameter; and
generate a virtual position for each participant voice, using spatial positioning, where a position of voices having similar characteristics is arranged distanced from each other in a virtual space.

2. The arrangement of claim 1, where the spatializing comprises at least one virtual sound-source positioning (VSP) method or a sound-field capture (SFC) method.

3. The arrangement of claim 1, further comprising:
a memory unit to store sound characteristics associated with a particular participant profile.

4. A computer for handling a multi-party conference, the computer comprising:
a unit for receiving signals corresponding to particular conferee voices;
a unit configured to analyze each of the signals;
a unit configured to extract at least one characteristic parameter from each signal;
a unit configured to compare the at least one characteristic parameter of at least each participant to determine a degree of similarity in the at least one characteristic parameter;
a unit configured to generate, using spatial positioning, a virtual position for each participant voice, where an audible position of voices having similar characteristics is arranged distanced from each other in a virtual space.

5. The computer of claim 4, further comprising:
a communication interface to a communication network.

6. A communication device for use in teleconferencing, the communication device comprising:
a communication portion;
a sound input unit;
a sound output unit;
a unit to analyze a signal received from said communication network, said signal corresponding to voices of a plurality of conferees;
a unit to extract at least one characteristic parameter for each of the voices;
a unit to compare the at least one characteristic parameter of pairs of conferees to determine a degree of similarity in the at least one characteristic parameter for each of the pairs of conferees; and
a unit to generate virtual positioning for each participant voice through spatial positioning, where distancing between pairs of conferees is based on the determined corresponding to each voice is to form a virtual conference configuration; and
a unit to output the virtual conference configuration via the sound output unit.

7. A method in a multi-party conferencing system, the method comprising:
analyzing signal relating to one or more participant voices;
processing at least each received signal and extracting at least one characteristic parameter for voice of each participant based on the signal;
comparing result of the characteristic parameters to find similarity in the characteristic parameters; and
generating a virtual position for each participant voice through spatial positioning, in which position of voices having similar characteristics is arranged distanced from each other in a virtual space.
